(19) United States
(12) Patent Application Publication
(10) Pub. No.: US 2014/0356605 A1
(43) Pub. Date: Dec. 4, 2014

(54) Antimicrobial Articles and Methods of Making and Using Same

(71) Applicant: Corning Incorporated, Corning, NY (US)

(72) Inventors: Kaveh Adib, Corning, NY (US); Matthew John Dejneka, Corning, NY (US); Shari Elizabeth Koval, Beaver Dams, NY (US)

(73) Assignee: CORNING INCORPORATED, CORNING, NY (US)

(21) Appl. No.: 14/288,811

(22) Filed: May 28, 2014

Related U.S. Application Data
(60) Provisional application No. 61/829,595, filed on May 31, 2013.

(51) Int. Cl. C03C 21/00

(52) U.S. Cl. CPC C03C 21/005; C03C 21/002; C03C 2204/02
USPC 428/220; 428/410; 428/426; 65/30.13; 65/30.14

(57) ABSTRACT

Described herein are glass, ceramic, or glass-ceramic articles having improved antimicrobial efficacy. Further described are methods of making and using the improved articles. The improved articles generally include a glass, ceramic, or glass-ceramic substrate, a compressive stress layer that extends inward from a surface of the glass, ceramic, or glass-ceramic substrate to a first depth therein, and an antimicrobial agent-containing region that extends inward from the surface of the glass, ceramic, or glass-ceramic substrate to a second depth therein.

This application claims the benefit of priority under 35 U.S.C. §119 of U.S. Provisional Application Ser. No. 61/829,595 filed on May 31, 2013, the content of which is relied upon and incorporated herein by reference in its entirety.

### BACKGROUND

The present disclosure relates generally to antimicrobial articles. More particularly, the various embodiments described herein relate to glass, ceramic, or glass-ceramic articles having improved antimicrobial behavior as well as to methods of making and using the articles.

Touch-activated or -interactive devices, such as screen surfaces (e.g., surfaces of electronic devices having user-interactive capabilities that are activated by touching specific portions of the surfaces), have become increasingly more prevalent. In general, these surfaces should exhibit high optical transmission, low haze, and high durability, among other features. As the extent to which the touch screen-based interactions between a user and a device increases, so too does the likelihood of the surface harboring microorganisms (e.g., bacteria, fungi, viruses, and the like) that can be transferred from user to user.

To minimize the presence of microbes, so-called “antimicrobial” properties have been imparted to a variety of glass and glass-ceramic articles. Such antimicrobial articles, regardless of whether they are used as screen surfaces of touch-activated devices or in other applications, can exhibit poor antimicrobial efficacy under ordinary use conditions despite performing adequately under generally-accepted or standardized testing conditions, can exhibit poor optical or aesthetic properties when exposed to certain conditions during fabrication and/or ordinary use, and/or can be costly to manufacture (e.g., when expensive metals or alloys are used as the antimicrobial agent or when additional steps are required to introduce the antimicrobial agent into or onto the glass or glass-ceramic). These deficiencies ultimately can make it impractical to implement the antimicrobial glass articles.

There accordingly remains a need for technologies that provide glass, ceramic, glass-ceramic, or other type articles with improved antimicrobial efficacy under both ordinary use and generally-accepted testing conditions. It would be particularly advantageous if such technologies did not adversely affect other desirable properties of the articles, such as optical or aesthetic properties. It would also be advantageous if such technologies could be produced in a relatively low-cost manner. It is to the provision of such technologies that the present disclosure is directed.

### BRIEF SUMMARY

Described herein are various antimicrobial glass, ceramic, or glass-ceramic articles that have improved antimicrobial efficacy, along with methods for their manufacture and use.

One type of improved antimicrobial article includes a glass, ceramic, or glass-ceramic substrate, a compressive stress layer that extends inward from a surface of the glass, ceramic, or glass-ceramic substrate to a first depth therein, and an antimicrobial agent-containing region that extends inward from the surface of the glass, ceramic, or glass-ceramic substrate to a second depth therein. In such an article, the second depth is less than or equal to about 1000 nanometers. In certain situations, the second depth can be about 2 nanometers to about 1000 nanometers. In some embodiments, the antimicrobial article may be free of a compressive stress layer. In such embodiments, the glass, ceramic or glass-ceramic substrate may have a substantially uniform compressive stress along the thickness thereof.

This type of antimicrobial article can further include an additional layer disposed on the surface of the substrate. The additional layer can include a reflection-resistant coating, a glare-resistant coating, fingerprint-resistant coating, smudge-resistant coating, a color-providing composition, an environmental barrier coating, or an electrically conductive coating. In some embodiments, the second depth of the antimicrobial agent-containing region is substantially stable (or does not significantly change) when the antimicrobial article is combined with an additional layer. For example, the second depth remains constant and may change less than about ±10 nm when the antimicrobial article includes an additional layer.

In certain implementations of this type of improved antimicrobial article, a compressive stress of the compressive stress layer can be about 200 megapascals (MPa) to about 1.2 gigapascals (GPa), and/or the depth of the compressive stress layer can be greater than or equal to about 25 micrometers and less than or equal to about 200 micrometers. The compressive stress layer of one or more embodiments may include at least one of potassium ions and sodium ions.

In some implementations of this type of improved antimicrobial article, the antimicrobial agent can include a cationic monovalent silver species, cationic monovalent copper species, cationic divalent zinc species, and/or a quaternary ammonium species.

In some embodiments, the antimicrobial agent concentration of an outermost 3 nanometers of the antimicrobial agent-containing region is up to about 10 atomic percent, based on a total number of atoms of the outermost 3 nanometers of the antimicrobial agent-containing region.

In one or more embodiments, the glass, ceramic or glass-ceramic substrate comprises a thickness of about 0.8 mm or less. In some instances, the thickness of the substrate may be about 0.5 mm or less or about 0.4 mm or less. In some embodiments, the glass, ceramic or glass-ceramic substrate may have a thickness of less than about 0.1 mm and/or may be adapted for roll-to-roll processing or adapted to be wound onto a spool.

The surface of the antimicrobial article of one or more embodiments may be etched. The etched surface may be simultaneously formed with the antimicrobial agent-containing region of the article.

In one or more embodiments, the antimicrobial article exhibits at least a 2 log reduction in the concentration of at least Staphylococcus aureus, Enterobacter aerogenes, and Pseudomomas aeruginosa bacteria under a Dry Test, as described herein. In some embodiments, the antimicrobial article exhibits at least a 3 log reduction in a concentration of at least Staphylococcus aureus, Enterobacter aerogenes, and Pseudomomas aeruginosa bacteria under JIS Z 2801 (2000) testing conditions. This type of antimicrobial article can also exhibit at least a 1 log reduction in a concentration of at least Staphylococcus aureus, Enterobacter aerogenes, and Pseudomomas aeruginosa bacteria under modified JIS Z 2801 (2000) testing conditions, wherein the modified conditions comprise heating the antimicrobial glass article to a temperature of about 23 degrees Celsius to about 37 degrees Celsius at a humidity of about 38 percent to about 42 percent for about 24 hours followed by drying for about 6 hours to about 24 hours.

In one or more embodiments, the improved antimicrobial glass article can serve as a portion of a touch-sensitive display screen or cover plate for an electronic device, a non-touch-sensitive component of an electronic device, a surface of a household appliance, a surface of medical equipment, a surface of an architectural component, a biological or medical packaging vessel, or a surface of a vehicle component.

One type of method of making an antimicrobial glass article includes providing a glass, ceramic, or glass-ceramic substrate having a surface, and forming an antimicrobial agent-containing region that extends inward from the surface of the glass, ceramic, or glass-ceramic substrate to a depth of region, such that the depth of the antimicrobial agent-containing region is less than or equal to about 1000 nanometers or in the range from about 2 nm to about 1000 nm.

In some cases, forming the antimicrobial agent-containing region can involve contacting at least a portion of the surface of the glass, ceramic, or glass-ceramic substrate with an antimicrobial agent-containing solution effective to introduce antimicrobial agent on and into the glass, ceramic, or glass-ceramic substrate to the second depth. In one or more embodiments, the antimicrobial agent-containing solution has a pH in the range from about 4 to about 10. The antimicrobial agent-containing solution may include AgNO₃, CuCl, a combination of AgNO₃ and Zn(NO₃)₂, and/or a combination of AgNO₃ and KNO₃. In one or more embodiments, the contacting step may occur for less than or equal to about 24 hours at a temperature of less than or equal to about 140 degrees Celsius.

In one or more embodiments, the method includes forming a compressive stress layer in the glass, ceramic or glass-ceramic substrate by, for example, tempering or chemical ion exchanging processes (e.g., by immersing the substrate in a molten salt bath comprising KNO₃, NaNO₃ or a combination thereof). Formation of the compressive stress layer may occur before or after forming the antimicrobial agent-containing region. The compressive stress layer of one or more embodiments may extend inward from the surface of the glass, ceramic or glass-ceramic substrate to a compressive stress depth. In some embodiments the depth of region is less than the compressive stress depth.

In some embodiments of the method, forming an antimicrobial agent-containing region includes simultaneously etching the surface of the glass, ceramic or glass-ceramic substrate.

In some cases, the method can also include forming an additional layer on at least a portion of the surface of the substrate, wherein the additional layer comprises a reflection-resistant coating, a glare-resistant coating, fingerprint-resistant coating, smudge-resistant coating, a color-providing composition, an environmental barrier coating, or an electrically conductive coating. In some cases, the step of forming the additional layer can occur before the step of forming the antimicrobial agent-containing region.

It is to be understood that both the foregoing brief summary and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 shows an energy dispersive spectroscopy (EDS) X-ray photoelectron spectroscopy (XPS) depth profile in terms of atomic % of Comparative Example A and Examples B and C;

FIG. 2 is a graph showing antimicrobial efficacy of Comparative Example D and Example C;

FIG. 3 is a Weibull plot showing the average flexural strength of Comparative Example E and Examples F and G;

FIG. 4 is a graph showing color coordinates (L*, a*, b*) for Comparative Example H, Example J and Comparative Example I;

FIG. 5 is a graph comparing the antimicrobial agent concentration profile, as a function of depth of antimicrobial agent-containing region, for Examples L23 and L70;

FIG. 6 is a graph showing the antimicrobial agent concentration profile, as a function of depth of antimicrobial agent-containing region, for Example L65; and

FIG. 7 is a graph showing Dry Test results of Example O1 and Comparative Example O2.

### DETAILED DESCRIPTION

Referring now to the figures, wherein like reference numerals represent like parts throughout the several views, exemplary embodiments will be described in detail. Throughout this description, various components may be identified having specific values or parameters. These items, however, are provided as being exemplary of the present disclosure. Indeed, the exemplary embodiments do not limit the various aspects and concepts, as many comparable parameters, sizes, ranges, and/or values may be implemented. Similarly, the terms “first,” “second,” “primary,” “secondary,” “top,” “bottom,” “distal,” “proximal,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Described herein are various antimicrobial articles that have improved antimicrobial efficacy both under ordinary use conditions and under generally-accepted testing conditions, along with methods for their manufacture and use. The term “antimicrobial” refers herein to the ability to kill or inhibit the growth of more than one species of more than one type of microbe (e.g., bacteria, viruses, fungi, and the like). In general, the improved articles and methods described herein involve the use of an antimicrobial agent-containing solution to create a shallow region having a suitable concentration of antimicrobial agent at the surface of the glass, ceramic, or glass-ceramic substrate. The shallow antimicrobial agent-containing region beneficially provides the article with improved antimicrobial efficacy both under ordinary use conditions and under generally-accepted testing conditions relative to similar or identical articles that lack an antimicrobial-agent containing region and/or have deeper antimicrobial-agent containing regions using the same amount of antimicrobial agent. The tailored antimicrobial-agent containing region provides additional benefits of improved mechanical performance, lower processing temperatures, and reduced use and waste related to the antimicrobial agent. In addition, and as will be described in more detail below, the articles can exhibit appropriate transmission, haze, and/or durability, among other features that may be desired for a particular application.

The improved antimicrobial glass articles described herein generally include a glass, ceramic, or glass-ceramic substrate, an optional compressive stress layer or region that extends inward from a surface of the substrate to a first depth, and an antimicrobial agent-containing layer or region comprising an antimicrobial agent that extends inward from a surface of the substrate to a second depth therein, wherein the second depth is shallower than the first depth.

Throughout this specification, the term “compressive stress layer” shall be used to refer to the layer or region of compressive stress, and the term “antimicrobial agent-containing region” shall be used to refer to the layer or region containing the antimicrobial agent. This usage is for convenience only, and is not intended to provide a distinction between the terms “region” and “layer” in any way. The depth of the compressive stress layer may be referred to herein as the “first depth”, “depth of layer” or the “compressive stress depth”. The depth of the antimicrobial agent-containing region may be referred to herein as the “second depth” or the “depth of region”.

The choice of glass, ceramic, or glass-ceramic material is not limited to a particular composition, as improved antimicrobial efficacy can be obtained using a variety of glass, ceramic, or glass-ceramic compositions. For example, with respect to glasses, the material chosen can be any of a wide range of silicate, borosilicate, aluminosilicate, or boroaluminosilicate glass compositions, which optionally can comprise one or more alkali and/or alkaline earth modifiers.

By way of illustration, one family of compositions includes those having at least one of aluminum oxide or boron oxide and at least one of an alkali metal oxide or an alkali earth metal oxide, wherein −15 mol %≦(R₂O+R′O—Al₂O₃—ZrO₂)—B₂O₃≦4 mol %, where R can be Li, Na, K, Rb, and/or Cs, and R′ can be Mg, Ca, Sr, and/or Ba. One subset of this family of compositions includes from about 62 mol % to about 70 mol % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. Such glasses are described more fully in U.S. patent application Ser. No. 12/277,573 by Matthew J. Dejneka et al., entitled “Glasses Having Improved Toughness And Scratch Resistance,” filed Nov. 25, 2008, and claiming priority to U.S. Provisional Patent Application No. 61/004,677, filed on Nov. 29, 2008, the contents of which are incorporated herein by reference in their entireties as if fully set forth below.

Another illustrative family of compositions includes those having at least 50 mol % SiO₂ and at least one modifier selected from the group consisting of alkali metal oxides and alkaline earth metal oxides, wherein [(Al₂O₃ (mol %)+B₂O₃ (mol %))/(Σalkali metal modifiers (mol %))]>1. One subset of this family includes from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. Such glasses are described in more fully in U.S. patent application Ser. No. 12/858,490 by Kristen L. Barefoot et al., entitled “Crack And Scratch Resistant Glass and Enclosures Made Therefrom,” filed Aug. 18, 2010, and claiming priority to U.S. Provisional Patent Application No. 61/235,767, filed on Aug. 21, 2009, the contents of which are incorporated herein by reference in their entireties as if fully set forth below.

Yet another illustrative family of compositions includes those having SiO₂, Al₂O₃, P₂O₅, and at least one alkali metal oxide (R₂O), wherein 0.75≦[(P₂O₅ (mol %)+R₂O (mol %))/M₂O₃ (mol %)]≦1.2, where M₂O₃=Al₂O₃+B₂O₃. One subset of this family of compositions includes from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O. Another subset of this family of compositions includes from about 40 to about 64 mol % SiO₂; from 0 mol % to about 8 mol % B₂O₃; from about 16 mol % to about 28 mol % Al₂O₃; from about 2 mol % to about 12 mol % P₂O₅; and from about 12 mol % to about 16 mol % R₂O. Such glasses are described more fully in U.S. patent application Ser. No. 13/305,271 by Dana C. Bookbinder et al., entitled “Ion Exchangeable Glass with Deep Compressive Layer and High Damage Threshold,” filed Nov. 28, 2011, and claiming priority to U.S. Provisional Patent Application No. 61/417,941, filed Nov. 30, 2010, the contents of which are incorporated herein by reference in their entireties as if fully set forth below.

Yet another illustrative family of compositions includes those having at least about 4 mol % P₂O₅, wherein (M₂O₃ (mol %)/RₓO (mol %))<1, wherein M₂O₃=Al₂O₃+B₂O₃, and wherein RₓO is the sum of monovalent and divalent cation oxides present in the glass. The monovalent and divalent cation oxides can be selected from the group consisting of Li₂O, Na₂O, K₂O, Rb₂O, Cs₂O, MgO, CaO, SrO, BaO, and ZnO. One subset of this family of compositions includes glasses having 0 mol % B₂O₃. Such glasses are more fully described in U.S. Provisional Patent Application No. 61/560,434 by Timothy M. Gross, entitled “Ion Exchangeable Glass with High Crack Initiation Threshold,” filed Nov. 16, 2011, the contents of which are incorporated herein by reference in their entirety as if fully set forth below.

Still another illustrative family of compositions includes those having Al₂O₃, B₂O₃, alkali metal oxides, and contains boron cations having three-fold coordination. When ion exchanged, these glasses can have a Vickers crack initiation threshold of at least about 30 kilograms force (kgf). One subset of this family of compositions includes at least about 50 mol % SiO₂; at least about 10 mol % R₂O, wherein R₂O comprises Na₂O; Al₂O₃, wherein −0.5 mol %≦Al₂O₃ (mol %)-R₂O (mol %)≦2 mol %; and B₂O₃, and wherein B₂O₃ (mol %)-(R₂O (mol %)-Al₂O₃ (mol %))≧4.5 mol %. Another subset of this family of compositions includes at least about 50 mol % SiO₂, from about 9 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO and/or ZnO, wherein 0≦MgO+ZnO≦6 mol %; and, optionally, at least one of CaO, BaO, and SrO, wherein 0 mol %≦CaO+SrO+BaO≦2 mol %. Such glasses are more fully described in U.S. Provisional Patent Application No. 61/653,485 by Matthew J. Dejneka et al., entitled “Ion Exchangeable Glass with High Damage Resistance,” filed May 31, 2012, the contents of which are incorporated herein by reference in their entirety as if fully set forth below.

In one or more embodiments, the substrate may include a glass composition of 56-72 mol % SiO₂; 5-22 mol % Al₂O₃; 0-15 mol % B₂O₃; 0-15 mol % P₂O₅; 0-15 mol % Li₂O; 0-22 mol % Na₂O; 0-10 mol % K₂O; 0-10 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦22 mol % and 0 mol %≦MgO+CaO≦10 mol %. In one or more specific embodiments, the substrate may include 56-72 mol % SiO₂; 5-22 mol % Al₂O₃; 0-15 mol % B₂O₃; 0-15 mol % P₂O₅; 0-15 mol % Li₂O; 0-22 mol % Na₂O; 0-10 mol % K₂O; 0-10 mol % MgO; 0-10 mol % CaO; 0-5 mol % ZrO₂; 0-1 mol % SnO₂; 0-1 mol % CeO₂ wherein 12 mol %≦Li₂O+Na₂O+K₂O≦22 mol %; 0 mol %≦MgO+CaO≦10 mol %; 3≦B₂O₃+P₂O₅≦15; −14≦(Li₂O+Na₂O+K₂O+Rb₂O+Cs₂O)—Al₂O₃≦2.

Optional compositions for use in the glass substrates may be free of alkali. In such examples, the glass substrates may include compositions suitable for use in display applications.

Similarly, with respect to ceramics, the material chosen can be any of a wide range of inorganic crystalline oxides, nitrides, carbides, oxynitrides, carbonitrides, and/or the like. Illustrative ceramics include those materials having an alumina, aluminum titanate, mullite, cordierite, zircon, spinel, persovskite, zirconia, ceria, silicon carbide, silicon nitride, silicon aluminum oxynitride, or zeolite phase.

Similarly, with respect to glass-ceramics, the material chosen can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

The substrate can adopt a variety of physical forms. That is, from a cross-sectional perspective, the substrate can be flat or planar, or it can be curved and/or sharply-bent. Similarly, it can be a single unitary object, a multi-layered structure, or a laminate. The substrate may be flexible, and thus adapted for roll-to-roll processing or adapted to be wound onto a spool. In such embodiments, the thickness of the substrate may be less than about 0.3 mm or less than about 0.1 mm (e.g., 50 nm).

Regardless of its composition or physical form, the substrate can include a layer or region under compressive stress that extends inward from a surface of the substrate to a specific depth therein (i.e., the first depth, DOL or compressive stress depth). This compressive stress layer can be formed from a strengthening process (e.g., by thermal tempering, chemical ion-exchange, or like processes). The amount of compressive stress (CS) and the depth of the compressive stress layer can be varied based on the particular use for the article, with the proviso, particularly for a glass article, that the CS and depth of the compressive stress layer should be limited such that a tensile stress created within the substrate as a result of the compressive stress layer does not become so excessive as to render the article frangible. In one or more embodiments, the compressive stress layer is formed by a chemical ion exchange process. The compressive stress layer may include potassium ions and/or sodium ions present from ion exchanging such ions into the substrate. In typical chemical ion exchange processes, smaller metal ions in the glass or glass ceramic are replaced or “exchanged” by larger metal ions of the same valence within a layer that is close to the outer surface of the substrate. The replacement of smaller ions with larger ions creates a compressive stress within the layer of the substrate. In one embodiment, the metal ions are monovalent alkali metal ions (e.g., Na⁺, K⁺, Rb⁺, and the like), and ion exchange is accomplished by immersing the substrate in a bath comprising at least one molten salt of the larger metal ion that is to replace the smaller metal ion in the substrate. The molten salt may include KNO₃ and/or NaNO₃. In one or more embodiments, the compressive stress layer includes a compressive stress in the range from about 200 megapascals (MPa) to about 1.2 gigapascals (GPa). In some embodiments, the compressive stress is about 300 MPa or greater, about 400 MPa or greater, about 500 MPa or greater, about 600 MPa or greater, about 700 MPa or greater or even about 800 MPa or greater. In one or more embodiments, the depth of the compressive stress layer may be less than about 200 micrometers. The lower limit of the depth of the compressive stress layer may be 0 micrometers, or may be about 15 micrometers.

In one or more alternative embodiments, the substrate does not include a compressive stress layer or, in other words, includes a substantially uniform compressive stress (which may be less than about 10 MPa) along the thickness of the substrate. In such embodiments, the substrate may be referred to as not tempered or not chemically strengthened. The substrate may nonetheless exhibit superior mechanical strength, when compared to other substrates that are not tempered or chemically strengthened, because of the presence of an etched surface(s), as will be described herein.

In addition, the substrate includes an antimicrobial agent-containing layer or region that extends inward from a surface of the substrate to a specific depth therein (i.e., the second depth or the depth of region). The antimicrobial agent can be chosen from any of a variety of species that provide antimicrobial behavior, examples of which include cationic monovalent silver (Ag⁺), cationic monovalent copper (Cu⁺), cationic divalent zinc (Zn²⁺), a quaternary ammonium species (NH₄⁺), and the like. In general, the average depth of the antimicrobial agent-containing region (DOR) will generally be limited to less than or equal to about 1000 nanometers (nm). In some embodiments, the average DOR may be in the range from about 2 nm to about 1000 nm, from about 50 nm to about 1000 nm, from about 50 nm to about 250 nm, or from about 250 nm to about 750 nm. Without being bound by theory, it is believed that a deeper or greater DOR may negatively influence mechanical properties of the antimicrobial article and a shallower or lower DOR may negatively influence antimicrobial activity in terms of longevity.

In one or more embodiments, the antimicrobial agent-containing region has a tailored concentration of antimicrobial agent species. In some embodiments, the concentration of the antimicrobial agent is measured along the outermost 3 nanometers of the antimicrobial agent-containing region. In some embodiments, the concentration of the antimicrobial agent is about 10 atomic percent or less, about 6 atomic percent or less, or about 3 atomic percent or less. In one or more embodiments, the concentration of the antimicrobial agent is from about 1 atomic percent to about 10 atomic percent, from about 1 atomic percent to about 8 atomic percent, from about 1 atomic percent to about 7 atomic percent, from about 1 atomic percent to about 6 atomic percent, from about 1 atomic percent to about 5 atomic percent, from about 1 atomic percent to about 4 atomic percent and all ranges and sub-ranges therebetween.

In such embodiments, the amount of antimicrobial agent is significantly less when compared to other known antimicrobial articles. For example, where the antimicrobial agent includes silver, the amount of silver used to form the antimicrobial agent-containing region of the embodiments described herein may be up to about 100 times less. This amount may be found in the reduced amount of silver in the substrate and/or used in the solution (when compared to the amount of silver used in known processes).

In certain implementations, the antimicrobial articles can include an additional functional layer disposed on the surface of the substrate. The optional additional layer(s) can be used to provide additional features to the antimicrobial article (e.g., reflection resistance or anti-reflection properties, glare resistance or anti-glare properties, fingerprint resistance or anti-fingerprint properties, smudge resistance or anti-smudge properties, color, opacity, environmental barrier protection, electronic functionality, and/or the like). Materials that can be used to form the optional additional layer(s) generally are known to those skilled in the art to which this disclosure pertains. By way of example, in one implementation, the optional additional layer might include a coating of SiO₂ nanoparticles bound to at least a portion of the substrate to provide reflection resistance to the final article. In another implementation, optional additional layer might comprise a multi-layered reflection-resistant coating formed from alternating layers of polycrystalline TiO₂ and SiO₂. In another implementation, the optional additional layer might comprise a color-providing composition that comprises a dye or pigment material. In another implementation, the optional additional layer might comprise a fingerprint-resistant coating formed from a hydrophobic and oleophobic material, such as a fluorinated polymer or fluorinated silane. In yet another implementation, the optional additional layer might comprise a smudge-resistant coating formed from an oleophilic material.

The articles described herein may include an etched surface. In such embodiments, the etched surface is formed simultaneously with the antimicrobial agent-containing region. In such embodiments, the etched surface has a reduced number of flaws and any flaws on the etched surface are reduced in size. In one or more embodiments, depth of the antimicrobial agent-containing region is tailored in relation to flaw depths in the surface of the articles. In one or more embodiments, the antimicrobial agent-containing region has a shallow depth (as described herein) that does not extend beyond typical flaw depths in the substrate (even after etching).

The antimicrobial activity and efficacy of the antimicrobial articles described herein can be quite high. The antimicrobial activity and efficacy can be measured in accordance with Japanese Industrial Standard JIS Z 2801 (2000), entitled “Antimicrobial Products—Test for Antimicrobial Activity and Efficacy,” the contents of which are incorporated herein by reference in their entirety as if fully set forth below. Under the “wet” conditions of this test (i.e., about 37° C. and greater than 90% humidity for about 24 hours), the antimicrobial articles described herein can exhibit at least a 3 log reduction in the concentration (or a kill rate of 99.999%) of at least Staphylococcus aureus, Enterobacter aerogenes, and Pseudomomas aeruginosa bacteria. In certain implementations, the antimicrobial articles described herein can exhibit at least a 5 log reduction in the concentration of any bacteria to which it is exposed under these testing conditions.

In scenarios where the wet testing conditions of JIS Z 2801 do not reflect actual use conditions of the antimicrobial articles described herein (e.g., when articles are used in electronic devices, or the like), the antimicrobial activity and efficacy can be measured using “drier” conditions. For example, the articles can be tested between about 23 and about 37° C. and at about 38 to about 42% humidity for about 24 hours. Specifically, 5 control samples and 5 test samples can be used, wherein each sample has a specific inoculum composition and volume applied thereto, with a sterile coverslip applied to the inoculated samples to ensure uniform spreading on a known surface area. The covered samples can be incubated under the conditions described above, dried for about 6 to about 24 hours, rinsed with a buffer solution, and enumerated by culturing on an agar plate, the last two steps of which are similar to the procedure employed in the JIS Z 2801 test. Using this test, the antimicrobial articles described herein can exhibit at least a 1 log reduction in the concentration (or a kill rate of 90%) of at least Staphylococcus aureus bacteria and at least a 2 log reduction in the concentration (or a kill rate of 99.99%) of at least Enterobacter aerogenes, and Pseudomomas aeruginosa bacteria. In certain implementations, the antimicrobial articles described herein can exhibit at least a 3 log reduction in the concentration of any bacteria to which it is exposed under these testing conditions.

In other scenarios where the wet testing conditions of JIS Z 2801 do not reflect actual use conditions of the antimicrobial articles described herein (e.g., when the glass articles are used in electronic devices, or the like), the antimicrobial activity and efficacy can be measured using “dry” conditions. These conditions described herein are collectively referred to herein as a “Dry Test”. The antimicrobial articles may exhibit at least a 1 log reduction in the concentration (or a kill rate of 90%) or even at least a 2 log reduction in the concentration (or kill rate of 99%) of at least Staphylococcus aureus, Enterobacter aerogenes, and Pseudomomas aeruginosa bacteria when tested under the Dry Test, which is described in U.S. Provisional Patent Application No. 61/908,401, which is hereby incorporated by reference in its entirety as if fully set forth below. Under the Dry Test, an inoculum is prepared as follows: inoculating nutrient agar with a portion of a stock having a plurality of bacterial organisms to form a culture, incubating the culture to form a first incubated culture, incubating a portion of the first incubated culture with nutrient agar to form a second incubated culture, incubating a portion of the second incubated culture with nutrient agar to form a third incubated culture, incubating the third incubated culture for approximately 48 hours to form an inoculated test plate with a plurality of bacterial colonies, and suspending a portion of the plurality of bacterial colonies in a buffered test solution of Minimum Essential Medium solution with 15% Fetal Bovine Serum (FBS), adjusting the test solution to a pH of approximately 7 to 8, and adding an organic soil serum at a concentration of approximately 10% to 30% by weight to the test solution. Each of the samples is innoculated with the inoculum and incubated for about 2 hours. Each sample is then washed in a neutralizing solution to form a residual test inoculum. The number of surviving bacterial colonies per volume in the residual test inoculum is then counted to calculate the percent reduction in the number of surviving bacterial colonies in the residual test inoculum (relative to a control residual inoculum).

Methods of making the above-described articles generally include the steps of providing a substrate with a surface, and forming an antimicrobial agent-containing region that extends inward from the surface of the substrate to a depth, as described herein.

In one or more embodiments, the method includes forming the antimicrobial agent-containing region via chemical diffusion (which optionally can be accompanied by the exchange of a cation out from the substrate) of an antimicrobial agent into the substrate. In one or more embodiments, the method includes contacting at least a portion of the surface of the substrate with an antimicrobial agent-containing solution.

In one or more embodiments, the antimicrobial agent-containing solution may include the antimicrobial agent, or a precursor to the antimicrobial agent, at least partially dissolved in a solvent. In most implementations, the antimicrobial agent can be at least partially dissolved in the solvent in the form of a salt of the antimicrobial agent. By way of example, when the antimicrobial agent is Ag it can be dissolved in the solvent as silver nitrate, silver chloride, silver acetate, silver cyanide, silver lactate, silver methanesulfonate, silver triflate, silver fluoride, silver permanganate, silver sulfate, silver nitrite, silver bromate, silver salicylate, and silver iodate, to name a few. Similar such salts can be made for other antimicrobial agents, including Cu⁺, Zn²⁺, NH₄⁺, and the like. For example, the antimicrobial agent-containing solution can include CuCl, a combination of AgNO₃ and Zn(NO₃)₂, and/or a combination of AgNO₃ and KNO₃. Without being bound by theory, it is believed that multiple and different ions can be introduced in the antimicrobial agent-containing solution to tailor the surface chemistry and stress profile of the article, and such ions may act synergistically to enhance the antimicrobial activity beyond that expected for each ion alone.

The solvent used in the antimicrobial agent-containing solution can be chosen from any of a variety of solvents, with the proviso that the solvent does not adversely affect (e.g., react with, decompose, volatilize, or the like) the substrate, the compressive stress layer, or the optional additional functional layer(s). Examples of such solvents include water, alcohols (e.g., methanol, ethanol, propanol, butanol, and the like), polar aprotic solvents (e.g., tetrahydrofuran, ethyl acetate, acetone, dimethylformamide, acetonitrile, dimethyl sulfoxide, methylpyrrolidone, and the like), and the like.

In one or more embodiments, the concentration of the antimicrobial agent may be in the range from about 0.01 to about 100 moles/liter, from about 0.1 to about 100 moles/liter, from about 0.6 to about 100 moles/liter, from about 1 to about 100 moles/liter, from about 5 to about 100 moles/liter, from about 10 to about 100 moles/liter, from about 20 to about 100 moles/liter, from about 30 to about 100 moles/liter, from about 40 to about 100 moles/liter, from about 0.01 to about 90 moles/liter, from about 0.01 to about 80 moles/liter, from about 0.01 to about 70 moles/liter, from about 0.01 to about 60 moles/liter, from about 0.01 to about 50 moles/liter, from about 0.1 to about 90 moles/liter, from about 0.1 to about 80 moles/liter, from about 0.1 to about 70 moles/liter, from about 0.1 to about 60 moles/liter, from about 0.1 to about 50 moles/liter, from about 0.6 to about 90 moles/liter, from about 0.6 to about 80 moles/liter, from about 0.6 to about 70 moles/liter, from about 0.6 to about 60 moles/liter, from about 0.6 to about 50 moles/liter, from about 10 to about 20 moles/liter and all ranges and sub-ranges therebetween. Additional examples are shown in Table 1.

In certain cases, it may be desirable to include additional components in the antimicrobial agent-containing solution. For example, the antimicrobial agent-containing solution can further include an alkali metal cation dissolved therein for the purpose of altering the stress profile of the compressive stress layer. Such cations can also synergistically enhance the antimicrobial efficacy of the final article. In certain examples, the antimicrobial agent-containing solution can include a stabilizer, surfactant, wetting agent, pH modifiers, or the like for enhancing the shelf life of the antimicrobial agent-containing solution. Examples of pH modifiers include NH₄OH, KOH, NaOH, silicic acid, ethylene glycol, ascorbic acid and the like.

In one or more embodiments, the method may include controlling the pH of antimicrobial agent-containing solution to a level in the range from about 4 to about 10. In such embodiments, the method includes modifying the pH of the antimicrobial agent-containing solution so it is in the range from about 5 to about 9, from 6 to about 8, or from about 6.5 to about 7.5. As will be described herein, the solution may have a pH level such that the solution can provide an etching function that can remove surface flaws from the substrate, while the antimicrobial agent-containing region is formed.

In one example, the antimicrobial agent-containing solution may be formed by, dissolving about 257 grams of AgNO₃ at 25° C. in 100 ml of H₂O (15 moles/liter). The resulting solution is acidic and can be used to etch the substrate while forming the antimicrobial agent-containing region. In some embodiments, where such etching is not needed or desired, the pH of the antimicrobial agent-containing solution can be modified by titrating in a few drops of ammonium hydroxide solution to adjust the pH back to around 7.0, where the solution is not corrosive to the substrates. In such embodiments, the use of such a solution may result in deeper penetration of the Ag⁺ ions since the newly exchanged substrate is not etched away.

In another example, CuCl may be used as the antimicrobial agent precursor. CuCl has very low solubility in pure H₂O; however, the method can include making a 50/50 solution of water and ammonium hydroxide to increase the solubility up to 250 g/l (3.6 Molar).

Other exemplary antimicrobial agent-containing solutions are shown in Tables 1 and 2.

Once the antimicrobial agent-containing solution is formed or selected, it can be contacted with the substrate to form the antimicrobial agent-containing region. Such contacting can take the form of partial or complete immersion of the substrate in the antimicrobial agent-containing solution, spraying the antimicrobial agent-containing solution on the surface of the substrate, and/or the like. In one or more embodiments, the length of time and the temperature of the antimicrobial agent-containing solution may be controlled to provide the requisite antimicrobial agent concentration and/or depth of antimicrobial agent-containing region. For example, in one or more embodiments, the substrate may be in contact with the antimicrobial agent-containing solution for up to two (2) weeks and the solution may have a temperature up to and including about 160° C. In some embodiments, the substrate may be in contact with the antimicrobial agent-containing solution for a duration in the range from about 2 hours to about 24 hours, from about 2 hours to about 96 hours or from about 2 hours to about 240 hours, and the solution may have a temperature in the range from about −20° C. to about 120° C., from about 0° C. to about 120° C., from about 90° C. to about 140° C., from about 15° C. to about 85° C. or from about 25° C. to about 75° C. In some examples, the temperature of the solution should be controlled (e.g., to a temperature not exceeding 140° C.) to avoid solidification of the solution. In some other examples, the temperature of the solution should be maintained at or above 85° C. to control the time for which the substrate is in contact with the solution. In other examples, the temperature may be increased to increase the speed of antimicrobial agent diffusion.

The method of one or more embodiments may include simultaneously etching the surface of the substrate and forming the antimicrobial agent-containing region. In such embodiments, the method includes modifying the pH of the antimicrobial agent-containing solution to provide an acidic antimicrobial agent-containing solution (e.g., having a pH of less than about 7). In one or more embodiments, the method includes etching the surface of the substrate to remove flaws in the surface. In one or more embodiments, the method includes forming an antimicrobial agent-containing region having a depth less than the average depth or longest flaws in the substrate.

In one or more alternative embodiments, the method includes modifying the pH (e.g., to about 7 or above 7) of the antimicrobial agent-containing solution so the substrate is not etched. In such embodiments, the method includes forming an antimicrobial agent-containing region to a deeper depth than when an acidic antimicrobial agent-containing solution is utilized.

The method of one or more embodiments includes forming one or more optional additional layer at least a portion of the substrate. The method includes forming the optional additional layer before or after formation of the antimicrobial agent-containing layer.

Depending on the materials chosen, the optional additional layer(s) can be disposed or formed on the surface of the substrate using a variety of techniques. For example, the optional additional layer(s) can be fabricated independently using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, and the like), spray coating, spin-coating, dip-coating, inkjetting, sol-gel processing, or the like. Such processes are known to those skilled in the art to which this disclosure pertains.

By way of example, in one implementation, the method includes forming an additional functional layer before forming the antimicrobial agent-containing region and includes spin-coating a fluorinated silane material on the surface of the substrate to form a fingerprint-resistant coating, spin-coating a color-providing composition on the surface of the substrate, and contacting or immersing the substrate into an aqueous AgNO₃ solution to ion exchange Ag⁺ therein.

By way of another example, the method may include forming the antimicrobial agent-containing region before forming an optional additional functional layer by immersing the substrate into an aqueous CuCl solution to ion exchange Cu⁺ therein, followed by coating the substrate with a multi-layered reflection-resistant coating.

In some embodiments, the second depth of the antimicrobial-containing region is substantially stable and does not significantly change when combined with the optional additional layer. In one example, the optional additional layer is disposed on the substrate before the antimicrobial agent is added. In such examples, adding the antimicrobial agent occurs after the optional additional layer is combined with the substrate and thus, the resulting antimicrobial agent-containing region is not subjected to further processing and does not substantially change in terms of concentration, depth, oxidation state of the antimicrobial agent, or otherwise. In other known articles and methods, the antimicrobial agent-containing region is formed before an additional layer is disposed on the article. The processes used to dispose the additional layer often include high temperature processes which can alter the antimicrobial agent-containing region in terms of concentration, depth, oxidation state of the antimicrobial agent, or otherwise. In some instances, this sequence of formation in known articles and methods is necessitated by the process by which the antimicrobial agent-containing region is formed. Some such processes to form the antimicrobial agent-containing region are harsh and can degrade or deteriorate the additional layer, therefore, the antimicrobial agent-containing region is formed before the additional layers are disposed on the substrate. In the embodiments described herein, the process of forming the antimicrobial agent-containing region is compatible with downstream processes by which the additional layer(s) are formed and the additional layer(s) themselves.

The selection of materials used in the glass, ceramic, or glass-ceramic substrates, antimicrobial agent, and optional additional layers can be made based on the particular application desired for the final article. In general, however, the specific materials will be chosen from those described above.

The method may include selecting a glass, ceramic, or glass-ceramic object as-manufactured, or can include subjecting the as-manufactured glass, ceramic, or glass-ceramic object to a treatment. Examples of such pre-coating treatments include physical or chemical cleaning, physical or chemical etching, physical or chemical polishing, annealing, shaping, and/or the like. Such processes are known to those skilled in the art to which this disclosure pertains.

In one or more embodiments, the method includes forming a compressive stress layer in the substrate. Formation of the compressive stress layer can be accomplished in a variety of ways, of which thermal tempering and chemical ion exchange are the most common. Such techniques are known to those skilled in the art to which this disclosure pertains. In one example, the substrate is subjected to chemical ion exchange by immersing the substrate in a molten salt bath including 100% KNO3, for 2-4 hours. The bath may have a temperature in the range from about 380° C. to about 450° C. The thus strengthened substrate may have a surface compressive stress of greater than about 800 MPa and a depth of compressive stress layer of about 45 μm. The method may include forming the compressive stress layer in the substrate before or after any one of the formation of the antimicrobial agent-containing region or the one or more additional layers.

In some embodiments, the method includes forming the compressive stress layer in the substrate first and then forming the antimicrobial agent-containing region or, disposing the optional additional functional layer on the surface of the substrate.

Where the compressive stress layer is formed first, the contacting step for forming the antimicrobial agent-containing region can optionally be performed at an elevated temperature, with the proviso that the temperature should not 1) exceed a temperature at which the CS in the compressive stress layer is substantially affected (i.e., by greater than about 2 percent) during the contacting or 2) a boiling temperature of the antimicrobial agent-containing solution. In many implementations, the temperature of the contacting step generally will be less than or equal to about 140 degrees Celsius (° C.). The duration of the contacting step will be less than or equal to about 100 hours, but in most implementations will be less than or equal to about 24 hours.

It should be noted that between any of the above-described steps, the substrate can undergo a treatment in preparation for any of the subsequent steps. As described above, examples of such treatments include physical or chemical cleaning, physical or chemical etching, physical or chemical polishing, annealing, shaping, and/or the like.

Once the article is formed, it can be used in a variety of applications where the article will come into contact with undesirable microbes. These applications encompass touch-sensitive display screens or cover plates for various electronic devices (e.g., cellular phones, personal data assistants, computers, tablets, global positioning system navigation devices, and the like), non-touch-sensitive components of electronic devices, surfaces of household appliances (e.g., refrigerators, microwave ovens, stovetops, oven, dishwashers, washers, dryers, and the like), medical equipment, architectural applications, biological or medical packaging vessels, and vehicle components, just to name a few devices.

Given the breadth of potential uses for the improved antimicrobial articles described herein, it should be understood that the specific features or properties of a particular article will depend on the ultimate application therefor or use thereof. The following description, however, will provide some general considerations.

There is no particular limitation on the average thickness of the substrate contemplated herein. In many exemplary applications, however the average thickness will be less than or equal to about 25 millimeters (mm). If the antimicrobial article is to be used in applications where it may be desirable to optimize thickness for weight, cost, and strength characteristics (e.g., in electronic devices, or the like), then even thinner substrates (e.g., less than or equal to about 5 mm) can be used. By way of example, if the antimicrobial article is intended to function as a cover glass for a touch screen display, then the glass substrate can exhibit an average thickness of about 0.02 mm to about 2.0 mm. In specific embodiments, the glass substrate may have a thickness of about 0.8 mm or less, about 0.7 mm or less, about 0.6 mm or less, about 0.5 mm or less, or about 0.4 mm or less. In some embodiments, the thickness of the glass, ceramic, or glass-ceramic substrate may be less than about 0.3 mm or less than about 0.1 mm so that the substrate is adapted for roll-to-roll processing or adapted to be wound onto a spool.

While the ultimate limit on the CS and depth of the compressive stress layer is the avoidance of rendering the substrate frangible, the average depth of the compressive stress layer of the compressive stress layer generally will be less than about one-third of the thickness of the substrate. The CS and depth of the compressive stress layer can be measured using a surface stress meter, which is an optical tool that generally uses the photoelastic constant and index of refraction of the substrate material itself, and converts the measured optical interference fringe patterns to specific CS and depth of the compressive stress layer values. In most applications, the average depth of the compressive stress layer will be greater than or equal to about 25 μm and less than or equal to about 100 μm. Similarly, the average CS across the depth of the compressive stress layer generally will be between about 200 MPa and about 1.2 GPa. In most applications, the average CS will be greater than 400 MPa.

As stated above, the average thickness of the antimicrobial agent-containing region should be less than or equal to about 1000 nm. In most applications, the average DOR will be greater than or equal to about 2 nm and less than or equal to about 1000 nm (or about 250 nm or less, about 550 nm or less or about 600 nm or less). In embodiments where the substrate is susceptible to visible coloration from the antimicrobial agent, the average DOR should be less than or equal to about 550 nm, 250 nm or 50 nm.

Within this region, antimicrobial agent concentrations at the outermost portion of this region (which includes about the outermost 3 nm) of up to about 10 atomic percent, based on the total number of atoms of this portion of the antimicrobial agent-containing region, can be attained, as measured using, for example, X-ray photoelectron spectroscopy (XPS) of secondary ion mass spectroscopy (SIMS). In most implementations, the antimicrobial agent concentration in the outermost portion of this region may be about 1 atomic percent to about 6 atomic percent.

When an optional additional layer is used, the average thickness of such a layer will depend on the function it serves. For example if a glare- and/or reflection-resistant layer is implemented, the average thickness of such a layer should be less than or equal to about 200 nm. Coatings that have an average thickness greater than this could scatter light in such a manner that defeats the glare and/or reflection resistance properties. Similarly, if a fingerprint- and/or smudge-resistant layer is implemented, the average thickness of such a layer should be less than or equal to about 100 nm.

In general, the optical transmittance of the antimicrobial article will depend on the type of materials chosen. For example, if a glass substrate is used without any pigments added thereto and/or any optional additional layers are sufficiently thin, the article can have an average transmittance over the entire visible spectrum (e.g., in the range from about 400 nm to about 700 nm) of at least about 85% (based on a 1 mm thick pathlength). In certain cases where the antimicrobial article is used in the construction of a glass touch screen for an electronic device, for example, the average transmittance of the antimicrobial glass article can be at least about 90% over the visible spectrum (based on a 1 mm thick pathlength). In other cases, the average transmittance may be about 91% or greater, over the visible spectrum (based on a 1 mm thick pathlength). In situations where the substrate comprises a pigment (or is not colorless by virtue of its material constituents) and/or any optional additional layers are sufficiently thick, the transparency can diminish, even to the point of being opaque across the visible spectrum. Thus, there is no particular limitation on the optical transmittance of the antimicrobial article itself.

In one or more embodiments, the depth and/or concentration of the antimicrobial agent-containing region may be tailored to optimize the optical properties of the antimicrobial article. In some embodiments, the reduced concentration of the antimicrobial agent in the antimicrobial agent-containing region may reduce the susceptibility of the agent to oxidation and/or precipitation of metallic colloids, and thus reduction in transmittance or yellowing of the article. In other embodiments, this may be accomplished by reducing the depth of the antimicrobial agent-containing region. As mentioned herein, the articles and methods described herein utilize a reduced amount of antimicrobial agents when compared to other known processes. In some embodiments, the reduced amount of antimicrobial agent may result in improved optical properties. For example, where silver is used as the antimicrobial agent, the reduced silver in turn reduces unwanted optical absorption in the blue region of the spectrum. In some embodiments, the reduction in optical absorption may be directly correlated to the reduced amount of silver antimicrobial agent used.

Like transmittance, the haze of the antimicrobial article can be tailored to the particular application. As used herein, the terms “haze” and “transmission haze” refer to the percentage of transmitted light scattered outside an angular cone of ±4.0° in accordance with ASTM procedure D1003, the contents of which are incorporated herein by reference in their entirety as if fully set forth below. For an optically smooth surface, transmission haze is generally close to zero. In those situations when the antimicrobial article is used in the construction of a glass touch screen for an electronic device, the haze of the article can be less than or equal to about 5%.

Regardless of the application or use, the antimicrobial articles described herein offer improved antimicrobial efficacy relative to identical articles that lack an antimicrobial-agent containing region and/or have deeper antimicrobial-agent containing regions using the same overall amount of antimicrobial agent.

In a specific embodiment that might be particularly advantageous for applications such as touch-accessed or -operated electronic devices, an antimicrobial glass article is formed from a chemically strengthened (ion exchanged) alkali aluminosilicate flat glass sheet. The average thickness of the glass sheet is less than or equal to about 1 mm, the average depth of compressive stress layer of the ion exchanged compressive stress layer on each major surface of the glass sheet will be about 40 μm to about 100 μm, and the average CS across the depth of the compressive stress layer on each major surface will be about 400 MPa to about 1.1 GPa. The average thickness of the antimicrobial agent-containing region, which is formed by an ion exchange step (using an aqueous silver nitrate solution in which the flat glass sheet is fully immersed for about 2 hours to about 24 hours at about 15° C. to about 85° C.) after the compressive stress layer is formed, will be about 2 nm to about 1000 nm. A silver concentration of about 1 atomic percent to about 6 atomic percent can be attained in the outermost (i.e., closest to the glass substrate surface) 3 nm of the antimicrobial silver-containing region, based on the total number of atoms of this portion of the antimicrobial silver-containing region as measured by XPS. This antimicrobial glass article can have an optical transmittance of at least about 90% across the visible spectrum and a haze of less than 1%.

In certain cases, one of the major surfaces of the glass sheet can have an anti-reflection coating, an anti-fingerprint coating, and/or a color-providing coating disposed on at least a portion thereof. Such an antimicrobial glass article can be used in the fabrication of a touch screen display for an electronic device, offering desirable strength, optical properties, and antimicrobial behavior. In addition, such an antimicrobial glass article can exhibit at least a 2 log reduction in the concentration of any bacteria to which it is exposed under the Dry Test conditions, at least a 3 log reduction in the concentration of any bacteria to which it is exposed under the testing conditions of JIS Z 2801, and at least a 1 log reduction in the concentration of any bacteria to which it is exposed under the drier testing conditions of the modified JIS Z 2801 test described above.

In another specific embodiment that might be particularly advantageous for architectural applications such as a hospital or other countertop, an antimicrobial glass-ceramic article is formed from a chemically strengthened shaped glass-ceramic object. The average thickness of the glass-ceramic object is about 10 mm to about 20 mm, the average depth of compressive stress layer of the ion exchanged compressive stress layer on each major surface of the glass-ceramic object will be about 50 μm to about 300 μm, and the average CS across the depth of the compressive stress layer on each major surface will be about 500 MPa to about 1.2 GPa. The average thickness of the antimicrobial agent-containing region, which is formed by an ion exchange step (using an aqueous copper chloride solution in which the glass-ceramic object is fully immersed for about 2 hours to about 24 hours at about 15° C. to about 85° C.) after the compressive stress layer is formed, will be about 2 nm to about 1000 nm. A copper concentration of about 1 atomic percent to about 7 atomic percent can be attained in the outermost (i.e., closest to the glass substrate surface) 3 nm of the antimicrobial copper-containing region, based on the total number of atoms of this portion of the antimicrobial copper-containing region as measured by XPS.

In addition, such an antimicrobial glass article can exhibit at least a 2 log reduction in the concentration of any bacteria to which it is exposed under the Dry Test, at least a 3 log reduction in the concentration of any bacteria to which it is exposed under the testing conditions of JIS Z 2801 and at least a 2 log reduction in the concentration of any bacteria to which it is exposed under the drier testing conditions of the modified JIS Z 2801 test described above.

### Examples

Comparative Example A and Examples B-C were prepared to evaluate the antimicrobial agent-containing region depth profile. Each of Comparative Examples A and Examples B-C were prepared using the same alkali aluminosilicate glass substrate. The substrate was subjected to chemical ion exchange by immersing the substrate in a 100% KNO₃ molten salt bath at a temperature of 420° C. for 2 hours and 15 minutes. The substrate had a surface compressive stress of about 990 MPa and a depth of compressive stress layer of 45 μm. The glass substrates had a composition of about 58 mol % silica, 16.5 mol % alumina, 17 mol % Na₂O, 3 mol % MgO and 6 mol % P₂O₅.

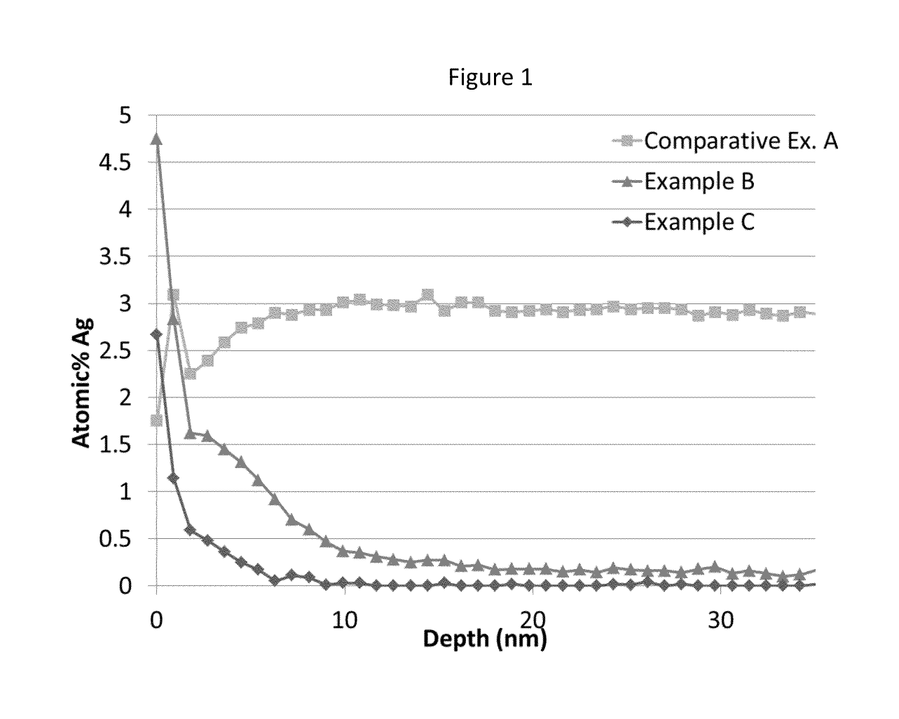

An antimicrobial agent-containing region was formed in Comparative Example A by immersing the substrate in a molten salt bath including 50% AgNO₃ and 50% KNO₃ and having a temperature of 350° C., for 2 minutes. An antimicrobial agent-containing region was formed in Example B by contacting the substrate with an aqueous solution including AgNO₃, saturated, having a temperature of about 50° C. and a pH of about 7 for 24 hours. The aqueous solution of AgNO₃ was formed by dissolving 257 grams of AgNO₃ in 100 ml of H₂O (15 moles/liter) at 25° C. The pH of the solution was modified by titrating in a few drops of ammonium hydroxide solution so the resulting pH was about 7.0. An antimicrobial agent-containing region was formed in Example C by contacting the substrate in the same aqueous solution as Example B, having the same temperature and pH, for about 2 hours. The silver profile (in terms of atomic %) as a function of depth was measured by EDS XPS and shown in FIG. 1.

FIG. 1 shows the silver ions in Examples B and C are limited to near the surface of the substrate (e.g., the firsts 5-10 nm), where the silver ions can access bacteria on the surface and thus effectively kill such bacteria. In Comparative Example A, the silver ion depth profile is significantly deeper.

Comparative Example D was prepared using the same substrate as used in Comparative Example A and Examples B-C. An antimicrobial agent-containing region was formed in Comparative Example D by contacting the substrate in a molten bath comprising 20% AgNO₃ and 80% KNO₃ having a temperature of about 350° C., for 2 minutes. The antimicrobial efficacy of Comparative Example D was evaluated and compared to the antimicrobial efficacy of Example C.

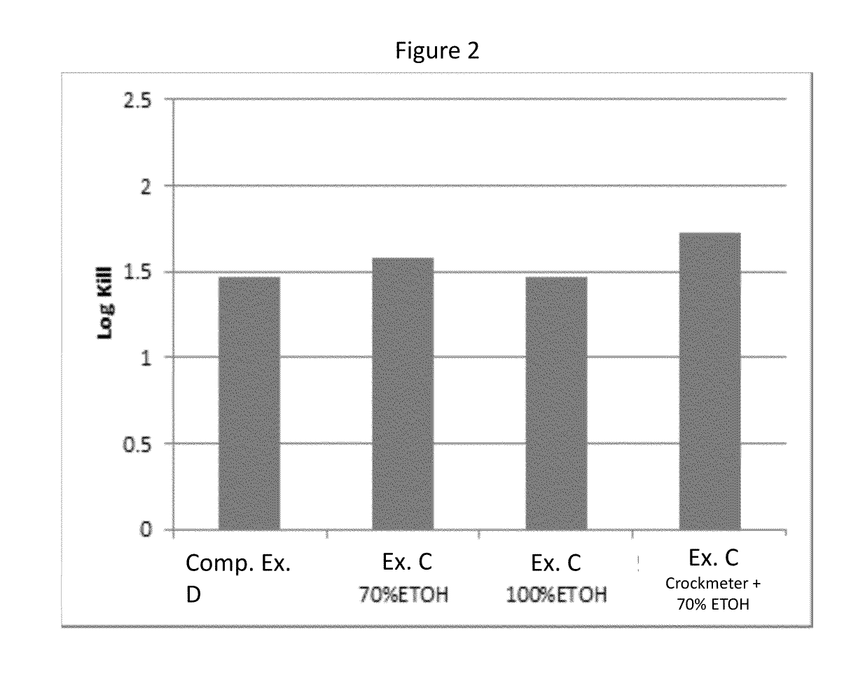

FIG. 2 illustrates the results under various conditions. Comparative Example D was tested for antimicrobial efficacy. Example C was tested using the same test, after the following conditions: 1) after being cleaned by wiping with 70% ethanol solution; 2) after being cleaned by wiping with a 100% ethanol solution; and 3) after cleaning by wiping with 70% ethanol solution and being subjected to 5000 wipes on a Crockmeter. FIG. 2 illustrates the antimicrobial efficacy of Example C did not change after being cleaned or subjected to numerous wipes.

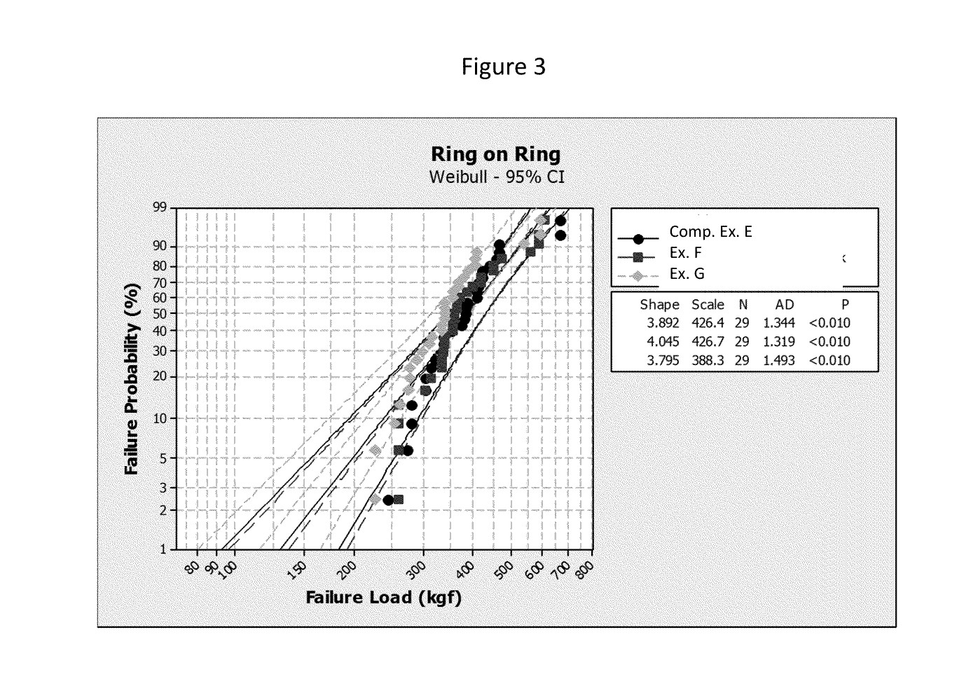

Samples according to Comparative Example E and Examples F and G were prepared using the same substrates as used in Comparative Example A and Examples B-D. The samples according to Examples F and G were contacted with an aqueous AgNO₃ solution. The solution was heated to a temperature of about 75° C. and the samples of Example F were contacted with the solution for 2 hours and 30 minutes. The solution was heated to a temperature of about 50° C. and the samples of Example G were contacted with the solution for 2 hours and 5 minutes. The samples according to Comparative Example E and Examples F and G were then subjected to ring-on-ring testing, which were generally performed according to the ASTM C-1499-03 standard test method for Monotonic Equibiaxial Flexural Strength of Advanced Ceramics at Ambient Temperatures, with a few modifications to test fixtures and test conditions as outlined in U.S. Patent Publication No. 2013/0045375, at [0027], incorporated by reference herein. Note that the samples tested to generate the data depicted in FIG. 3 were not abraded prior to testing. As shown in FIG. 3, the samples exhibited the same average flexural strength.

Comparative Examples H and I and Example J were prepared by providing three, identical and commercially available electronic tablet cover glasses. The cover glasses included a first major surface with an ink coating disposed on at least a portion of that major surface and a second major surface free of ink coating. The cover glass for Comparative Example H was a used as a control and not subjected to any further treatment. The cover glass for Comparative Example I was subjected to antimicrobial treatment by contacting the cover glass in an antimicrobial agent-containing solution including AgNO₃ having a temperature of 85° C. for 96 hours. The cover glass of Example J was laminated on the first major surface with a commercially available film, available under the tradename Seil Hi-Tech 550, such that the ink coating is disposed between the film and the cover glass. The cover glass of Example J was contacted with the same antimicrobial agent-containing solution having a temperature of 85° C., as Comparative Example I, for 96 hours. It was found that the laminate blocked ion exchange of the silver ions into the first major surface and thus the antimicrobial agent-containing region extended from the surface of the second major surface to a depth of region and the first major surface did not include an antimicrobial agent-containing region.

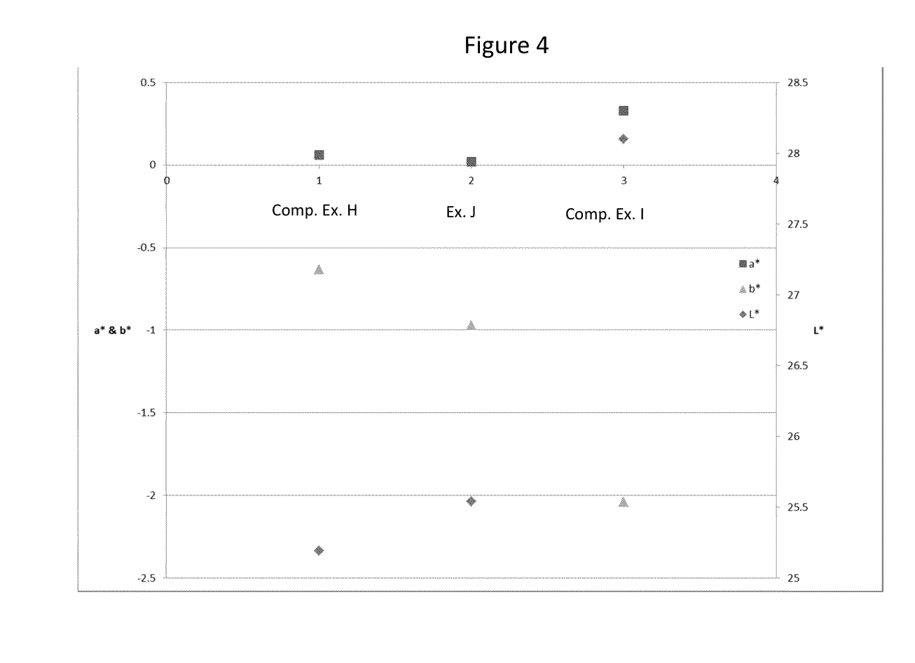

The color of the cover glasses of Comparative Examples H and I and Example J were evaluated in terms of L*, a*, and b* values under the International Commission on Illumination (“CIE”) L*, a*, b* colorimetry system. The color was evaluated through the second major surface. As shown in FIG. 4, the color coordinates L*, a* and b* of Comparative Example H and Example J were nearly the same, whereas the color coordinates of Comparative Example I changed substantially, especially in terms of b* and L*. Accordingly, it is found that the antimicrobial agent-containing solution can be used in conjunction with articles including coatings, including ink coatings, without affecting the color performance of the coating.

A visual inspection of the cover glasses showed that the ink coating of Comparative Example H (with no antimicrobial treatment) exhibited a dark, even black color. The cover glass of Comparative Example I exhibited significant deposits of silver that appeared as large gray spots and the surrounding regions were also a green-gray color and uneven in tone. The cover glass of Example J exhibited a dark, even black color that was nearly identical to that of Comparative Example H.

Example K includes exemplary antimicrobial agent-containing solutions that can be used in the methods described herein or to form the articles described herein. The exemplary antimicrobial agent-containing solutions are provided in Table 1.

TABLE 1
Exemplary antimicrobial agent-containing solutions.

| | | | Moles | Moles |
|---|---|---|---|---|
| Example | General Description | Mols/L | K/L | Zn/L |
| K1 | Saturated AgNO₃ (room | 10.18 | | |
| | temperature) | | | |
| K2 | Saturated AgNO₃ (room | 8.65 | | |
| | temperature) | | | |
| K3 | Saturated AgNO₃ (85° C.) | 22.00 | | |
| K4 | Saturated AgNO₃ (85° C.) | 17.53 | | |
| K5 | High temperature saturated | 20.17 | | |
| | AgNO₃ | | | |
| K6 | CuCl | 0.70 | | |
| K7 | AgNO₃/KNO3 - 90/10 | 7.89 | 0.88 | |
| K8 | AgNO₃/KNO3 - 10/90 | 1.04 | 9.36 | |
| K9 | Zn(NO₃)_{2.6}H₂O - stock | 2.27 | | |
| K10 | AgNO₃/Zn(NO₃)₂ - 1:1 | 8.77 | | 1.13 |
| K11 | AgNO₃/Zn(NO₃)₂ - 1:2 | 5.84 | | 1.51 |
| K12 | AgNO₃/Zn(NO₃)₂ - 1:10 | 1.58 | | 2.06 |
| K13 | AgNO3/Zn(NO₃)₂ - 2:1 | 11.69 | | 0.76 |
| K14 | AgNO₃/Zn(NO₃)₂ - 10:1 | 15.95 | | 0.21 |
| K15 | AgNO₃/DI H₂O - 1:1 | | | |
| K16 | AgNO₃/DI H₂O - 1:2 | | | |
| K17 | AgNO₃/DI H₂O - 1:10 | | | |
| K18 | AgNO3/DI H₂O - 2:1 | | | |
| K19 | AgNO3/DI H₂O - 10:1 | | | |
| K20 | Saturated AgNO₃ (120° C.) | 19.25 | | |
| K21 | 19.28 Mols/L AgNO₃ | 19.288 | | |
| | (solution A) (room temperature | | | |
| | saturated solution) | | | |
| K22 | 1.55 Mols/L AgNO₃ | 1.552 | | |
| | (solution B) | | | |
| K23 | 0.164 Mols/L AgNO₃ | 0.164 | | |
| | (solution C) | | | |
| K24 | 0.0165 Mols/L AgNO₃ | 0.0165 | | |
| | (solution D) | | | |

The pH of the exemplary antimicrobial agent-containing solutions of Table 1 can be adjusted with the addition of various pH modifiers. Exemplary pH values and the pH additives used to adjust the pH are provided in Table 2.

TABLE 2
Exemplary pH values of antimicrobial agent-containing solutions.

| Solution | pH | pH modifier |
|---|---|---|
| K1/K2 Room Temp saturated AgNO₃ | 4.5-5.5 | - |
| K3/K4 - 85° C. saturated AgNO₃ | 5 | - |
| K1/K2 Room Temp saturated AgNO₃ | 7 | NH₄OH, KOH, |
| | | NaOH |
| K21 - 19.28 Mols/L AgNO₃ (solution A) | 3 | |
| K22 - 1.55 Mols/L AgNO₃ (solution B) | 4 | |
| K23 - 0.164 Mols/L AgNO₃ (solution C) | 4-4.5 | |
| K24 - 0.0165 Mols/L AgNO₃ (solution D) | 4.5-5 | |
| K1/K2 - Room Temp saturated AgNO₃ | 3.5 | Silicic Acid |
| K1/K2 Room Temp saturated AgNO₃ | 5 | Ethylene Glycol |
| K6 - 0.7 mol/L CuCl solution | 5 | |
| K6 - 0.7 mol/L CuCl solution | 2.5-4 | 0.251 g ascorbic |
| | | acid |
| K6 - 0.7 mol/L CuCl solution | 3-4 | 0.251 g ascorbic |
| | | acid |
| K6 - 0.7 mol/L CuCl solution | 4-4.5 | 0.251 g ascorbic |
| | | acid |

Examples L1-L73 were formed by providing a substrate selected from Substrate A, Substrate B, Substrate C, Substrate D, Substrate E, Substrate F, Substrate G and Substrate H, as shown in Table 3, and forming a compressive stress layer and, in some cases, forming an antimicrobial agent-containing region in the substrate. Substrates A-G were glass substrates and Substrate H was an opaque, white glass ceramic.

TABLE 3
Nominal compositions of Substrates A-H, in mole %.

| | A | B | C | D | E | F | G | H |
|---|---|---|---|---|---|---|---|---|
| SiO₂ | 69.17 | 68.81 | 67.45 | 64.65 | 60 | 57.83 | 66.13 | 69.3 |
| Al₂O₃ | 8.53 | 10.26 | 12.69 | 13.93 | 15.38 | 16.53 | 12.73 | 12.6 |
| B₂O3 | | | 3.67 | 5.11 | | | 3.69 | 1.9 |
| Li₂O | | | | | | | | 7.7 |
| Na₂O | 13.94 | 15.25 | 13.67 | 13.75 | 16.49 | 16.51 | 13.17 | 0.4 |
| K₂O | 1.17 | | 0.02 | 0.00 | 0 | | 0.55 | |
| MgO | 6.45 | 5.46 | 2.36 | 2.38 | 2.88 | 2.55 | 1.63 | 2.9 |
| CaO | 0.54 | 0.06 | 0.03 | 0.14 | | 0.05 | 0.03 | |
| ZnO | | | | | | | | 1.7 |
| ZrO₂ | | | | | | | 0.01 | |
| TiO₂ | | | | | | | 1.32 | 3.5 |
| SnO₂ | 0.19 | 0.17 | 0.09 | 0.08 | 0.1 | 0.05 | 0.02 | 0.1 |
| Fe₂O₃ | | | | | | | 0.68 | |
| P₂O₅ | | | | 64.65 | 5.15 | 6.45 | | |

Two different treatments were used to form the compressive stress layer as shown in Table 4. The substrates were immersed in either one or two molten salt baths having the compositions and temperatures shown in Table 4. The duration of the immersion in the one or both baths is also shown in Table 4.

TABLE 4
Conditions used to form a compressive stress layer.
CS Condition 1

| | Temp range | time range |
|---|---|---|
| 1st bath | (° C.) | (mins) |
| 100% KNO₃ | 350-500 | 60-420 |

CS Condition 2

| | | | | Temp | time |
|---|---|---|---|---|---|
| | Temp range | time range | 2nd | range | range |
| 1st bath | (° C.) | (mins) | bath | (° C.) | (mins) |
| 50-99% KNO₃/ | 350-500 | 60-420 | 100% | 350-500 | 5-120 |
| 1-50% NaNO₃ | | | KNO₃ | | |

Thirteen different treatments were used to form the antimicrobial agent-containing layer as shown in Table 5. After formation of the compressive stress layer, the substrates were contacted with either a comparative antimicrobial agent-containing molten salt bath or an aqueous antimicrobial agent-containing solution (including the solutions provided in Table 1) having the compositions and temperatures shown in Table 5.

TABLE 5
Conditions used to form an antimicrobial agent-containing layer.

| AA Condition | Bath Composition |
|---|---|
| 1 | K2 (Saturated AgNO₃ (room temperature)) |
| 2 | K4 (Saturated AgNO₃ (85° C.)) |
| 3 | Molten: 20 mol % AgNO₃: 80 mol % KNO₃ |
| 4 | Molten: 90 mol % AgNO₃: 10 mol % KNO₃ |
| 5 | Molten: 10 mol % AgNO₃: 90 mol % KNO₃ |
| 6 | Molten: 100 mol % AgNO₃ |
| 7 | K21 (Dilution Series Solution A (RT sat. |
| | solution)) |
| 8 | K22 (Dilution Series Solution B) |
| 9 | K23 (Dilution Series Solution C) |
| 10 | K24 (Dilution Series Solution D) |
| 11 | K6 (CuCl) + 0.251 g Ascorbic Acid |
| 12 | K23 + Ethylene Glycol (80% by vol) |
| 13 | K21 + Silicic Acid |

Examples L1-L73 were prepared by providing one of Substrate A-H, forming a compressive stress layer by either CS Condition 1 or 2, and forming an antimicrobial agent-containing region by contacting the substrate (with the compressive stress layer) with an antimicrobial agent-containing solution including one of AA Condition 1-AA Condition 13, as shown in Table 6. Information as to whether the surface of the substrate was further processed for surface flaw removal (SFR) is also included in Table 6. The antimicrobial activity was measured by the Dry Test, as described herein, is also provided in Table 7, along with average flexural strength as measured by ring-on-ring (ROR) testing and the depth of the antimicrobial agent-containing region (DOR). The ROR tests were generally performed according to the ASTM C-1499-03 standard test method for Monotonic Equibiaxial Flexural Strength of Advanced Ceramics at Ambient Temperatures, with a few modifications to test fixtures and test conditions as outlined in U.S. Patent Publication No. 2013/0045375, at [0027], incorporated by reference herein. Note that the samples tested to generate the ROR data were not abraded prior to ROR testing.

TABLE 6
Examples L1-L73 Preparation and Evaluation.

| | | | | Temperature | Time in | |
|---|---|---|---|---|---|---|
| | | CS | AA | of AA bath | AA bath | |
| Example | Substrate | Condition | Condition | (° C.) | (hrs.) | SFR |
| L1 | E | 2 | 11 | 85 | 96 | None |
| L2 | E | 1 | 3 | 350 | 0.33 | None |
| (comparative) | | | | | | |
| L3 | E | 1 | 2 | 85 | 96 | None |
| L4 | E | 1 | 2 | 85 | 96 | Touch |
| | | | | | | polish |
| L5 | E | 1 | 2 | 85 | 96 | Acid |
| | | | | | | etch |
| L6 | F | 2 | 1 | 130 | 96 | None |
| L7 | F | 2 | 2 | 130 | 96 | None |
| L8 | G | 1 | 3 | 350 | 0.33 | None |
| (comparative) | | | | | | |
| L9 | G | 1 | 1 | 85 | 96 | None |
| L10 | H | 1 | 1 | 85 | 96 | None |
| L11 | H | 1 | 3 | 350 | 0.33 | None |
| L12 | F | 2 | 1 | 160 | 24 | |
| L13 | F | 2 | 2 | 160 | 24 | |
| L14 | F | 2 | 2 | 140 | 24 | |
| L15 | F | 2 | 2 | 150 | 24 | |
| L16 | B | 1 | 2 | 115 | 24 | |
| L17 | C | 1 | 2 | 115 | 24 | |
| L18 | E | 1 | 2 | 115 | 24 | |
| L19 | D | 1 | 2 | 115 | 24 | |
| L20 | F | 2 | 1 | 95 | 2 | |
| L21 | F | 2 | 1 | 95 | 24 | |
| L22 | F | 2 | 1 | 95 | 96 | |
| L23 | F | 2 | 2 | 85 | 24 | |
| L24 | F | 2 | 1 | 85 | 24 | |
| L25 | F | 2 | 1 | 85 | 96 | |
| L26 | F | 2 | 4 | 75 | 24 | |
| L27 | B | 1 | 1 | 85 | 96 | |
| L28 | B | 1 | 1 | 85 | 168 | |
| L29 | B | 1 | 1 | 85 | 240 | |
| L30 | B | 1 | 2 | 85 | 96 | |
| L31 | B | 1 | 2 | 85 | 168 | |
| L32 | B | 1 | 2 | 85 | 240 | |
| L33 | C | 1 | 1 | 85 | 96 | |
| L34 | C | 1 | 1 | 85 | 168 | |
| L35 | C | 1 | 1 | 85 | 240 | |
| L36 | C | 1 | 2 | 85 | 96 | |
| L37 | C | 1 | 2 | 85 | 168 | |
| L38 | C | 1 | 2 | 85 | 240 | |
| L39 | E | 1 | 1 | 85 | 96 | |
| L40 | E | 1 | 1 | 85 | 168 | |
| L41 | E | 1 | 1 | 85 | 240 | |
| L42 | D | 1 | 1 | 85 | 96 | |
| L43 | D | 1 | 1 | 85 | 168 | |
| L44 | D | 1 | 1 | 85 | 240 | |
| L45 | D | 1 | 2 | 85 | 96 | |
| L46 | D | 1 | 2 | 85 | 168 | |
| L47 | D | 1 | 2 | 85 | 240 | |
| L48 | F | 2 | 5 | | | |
| L49 | F | 2 | 4 | | | |
| L50 | F | 2 | 6 | | | |
| L51 | F | 2 | 7 | 95 | 24 | |
| L52 | F | 2 | 8 | 95 | 24 | |
| L53 | F | 2 | 9 | 95 | 24 | |
| L54 | F | 2 | 10 | 95 | 24 | |
| L55 | A | 1 | 10 | 95 | 96 | |
| L56 | F | 2 | 9 | 95 | 6 | |
| L57 | F | 2 | 9 | 95 | 16 | |
| L58 | F | 2 | 9 | 95 | 96 | |
| L59 | F | 2 | 9 | 130 | 3 | |
| L60 | F | 2 | 9 | 130 | 6 | |
| L61 | F | 2 | 9 | 130 | 16 | |
| L62 | F | 2 | 9 | 130 | 24 | |
| L63 | F | 2 | 10 | 95 | 6 | |
| L64 | F | 2 | 10 | 95 | 16 | |
| L65 | F | 2 | 10 | 95 | 96 | |
| L66 | F | 2 | 10 | 130 | 3 | |
| L67 | F | 2 | 10 | 130 | 6 | |
| L68 | F | 2 | 10 | 130 | 16 | |
| L69 | F | 2 | 10 | 130 | 24 | |
| L70 | F | 2 | 2 | 140 | 24 | |
| L71 | F | 2 | 2 | 140 | 24 | |
| L72 | F | 2 | 12 | 95 | 17.5 | |
| L73 | F | 2 | 13 | 100 | 0 | |

TABLE 7
Evaluation of Examples L1-L73.

| | | Control Log | | |
|---|---|---|---|---|
| Example | Log Kill | Kill | ROR (kgf) | DOR (nm) |
| L1 | | | | |
| L2 | | | 543.856 | |
| (comparative) | | | | |
| L3 | 2.21 | 2.36 | 487.91 | |
| L4 | 2.23 | 2.36 | 359.175 | |
| L5 | 2.09 | 2.36 | 452.907 | |
| L6 | 1.55 | 1.57 | | |
| L7 | 1.91 | 1.57 | | |
| L8 | | | 253 | |
| (comparative) | | | | |
| L9 | | | 257 | |
| L10 | | | 179 | |
| L11 | | | 161 | |
| L12 | | | | 560 |
| L13 | | | | 530 |
| L14 | | | | 235 |
| L15 | | | | 225 |
| L16 | | | | 68 |
| L17 | | | | 89 |
| L18 | | | | 110 |
| L19 | | | | 51 |
| L20 | 2.46 | 2.68 | | 20 |
| L21 | 2.81 | 2.68 | | 60 |
| L22 | 2.90 | 2.68 | | 86 |
| L23 | 2.90 | 2.68 | | |
| L24 | 3.00 | 2.68 | | |
| L25 | 2.78 | 2.68 | | |
| L26 | 2.85 | 2.68 | | |
| L27 | | | | 51.6 |
| L28 | | | | 59.3 |
| L29 | | | | 52 |
| L30 | | | | 49.6 |
| L31 | | | | 54.7 |
| L32 | | | | 46.8 |
| L33 | | | | 44.8 |
| L34 | | | | 52 |
| L35 | | | | 43 |
| L36 | | | | 32 |
| L37 | | | | 40 |
| L38 | | | | 53.7 |
| L39 | | | | 46 |
| L40 | | | | 42 |
| L41 | | | | 41.6 |
| L42 | | | | 25.6 |
| L43 | | | | 23 |
| L44 | | | | 32.9 |
| L45 | | | | 28.8 |
| L46 | | | | 51.2 |
| L47 | | | | 32 |
| L48 | | | | 23.6 |
| L49 | | | | 22 |
| L50 | | | | 26 |
| L51 | 3.06 | 2.73 | | 33 |
| L52 | 3.24 | 2.73 | | 37.5 |
| L53 | 3.19 | 2.73 | | 52 |
| L54 | 2.82 | 2.73 | | 58 |
| L55 | | | | |
| L56 | 3.02 | 2.99 | | 26 |
| L57 | 2.77 | 2.99 | | 48 |
| L58 | 2.78 | 2.99 | | 48 |
| L59 | 2.73 | 2.99 | | 27 |
| L60 | 2.74 | 2.99 | | 36 |
| L61 | 2.61 | 2.99 | | 36 |
| L62 | 2.95 | 2.99 | | 36 |
| L63 | 2.6 | 2.87 | | 26 |
| L64 | 2.9 | 2.87 | | 56 |
| L65 | 2.81 | 2.87 | | 60 |
| L66 | 2.82 | 2.87 | | 25 |
| L67 | 2.83 | 2.87 | | 34 |
| L68 | 3.17 | 2.87 | | 43 |
| L69 | 3.16 | 2.87 | | 45 |
| L70 | 2.25 | 2.45 | | |
| L71 | 1.59 | 2.45 | | |
| L72 | | | | |
| L73 | | | | |

In Table 7, some Examples were evaluated for a log kill under the Dry Test and were compared to a “Control Log Kill”, which was measured by forming the respective Example using the same substrate, the same CS conditions but using AA condition 3. Examples L70 and L71 compared the antimicrobial activity of identical examples before heat treating at 180° C. for 2 hours (Example L70) and after heat treating at 180° C. for 2 hours (Example L71). Examples M1-M3 were prepared by providing Substrates G (Examples M2-M3) and H (Example M1) and forming a compressive stress layer by immersing the substrates in a molten salt bath for 2 hours (Example M1) or 8 hours (Examples M2-M3), as shown in Table 8 below, and then forming an antimicrobial agent-containing region in the substrates by contacting the substrates (with the compressive stress layer) with an antimicrobial agent-containing solution including AA Condition 2, having a temperature of 85° C. for 96 hours. Example M3 was subjected to an acid etch process to remove surface flaws between the formation of the compressive stress layer and the antimicrobial agent containing region. The color coordinates in terms of Delta E was evaluated before and after formation of the antimicrobial agent-containing region. Delta E was evaluated under International Commission on Illumination (CIE) 1976 formula using (L*₁, a*₁, b*₁) as the coordinates before formation of the antimicrobial agent-containing region and (L*₂, a*₂, b*₂) as the coordinates after formation of the antimicrobial agent-containing region, by which Delta E=√((L*₂−L*₁)²+(a*₂−a*₁)²+(b*₂−b*₁)²).) The Delta E values are shown in Table 8.

TABLE 8
Delta E values for Examples M1-M3.

| | | CS | AA | |
|---|---|---|---|---|
| Example | Substrate | Condition | Condition | Delta E |
| M1 | H | 100% | 2 | 1.58 |
| | | NaNO₃ 430° C. | | |
| | | 2 hrs | | |
| M2 | G | 100% KNO₃ | 2 | 0.76 |
| | | 420° C. 8 hrs | | |
| M3 | G | 100% KNO₃ | Acid etch | 1.14 |
| | | 420° C. 8 hrs | followed | |
| | | | by 2 | |

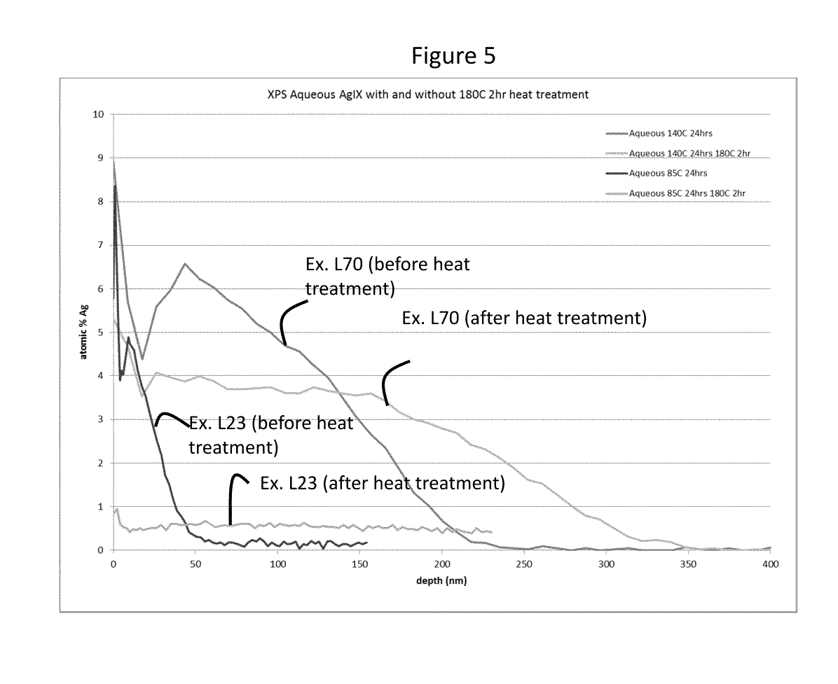

Examples L23 and L70 were evaluated before and after heat treating at 180° C. for 2 hours. Heat treatment of known antimicrobial articles can result in the silver or antimicrobial agent being driven into the article at deeper depths such that there is a decrease in the concentration of the antimicrobial agent at the surface of the article. The reduction in the antimicrobial agent content could result in lower antimicrobial performance. FIG. 5 is a graph illustrating the amount of silver (atomic %) as a function of depth from the surface of the substrates. In other words, FIG. 5 is a graph illustrating the silver concentration along the DOR. As shown in FIG. 5, Example L70 maintains a significant amount of silver at the surface (e.g., 8.9 atomic % before heat treatment and about 5.5 atomic % after heat treatment). Accordingly, the process by which the antimicrobial agent-containing region of Example L70 was formed results in a more robust antimicrobial agent-containing region that maintains the silver concentration, even when the article is exposed to heat treatment. Without being bound by theory, it is believed that a higher initial antimicrobial agent concentration at the surface and along the DOR before heat treatment (e.g., up to about 200 nm DOR) results in the maintenance of the antimicrobial agent concentration at the surface after heat treatment. For comparison, the antimicrobial agent concentration of Example L23 decreases drastically at a DOR of about 50 nm.

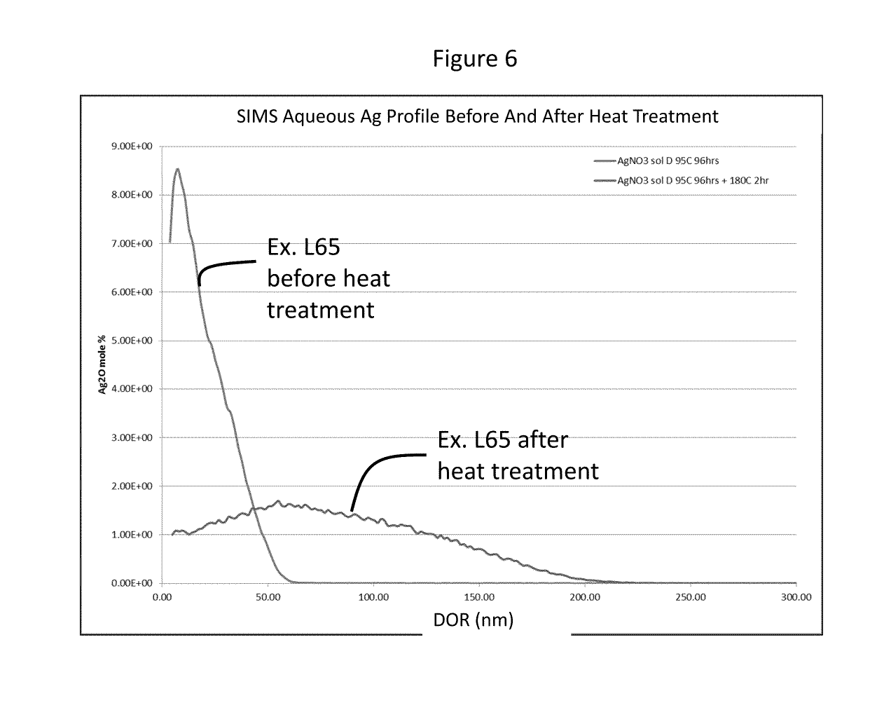

Example L65 was also evaluated before and after het treatment at 180° C. for 2 hours. FIG. 6 shows the change in silver concentration (mol %) before and after heat treating as a function of DOR. As shown in FIG. 6, heat treatment can cause silver to diffuse into the substrate.

Prophetic Example N1 includes particles having the same composition as Substrate F and having a particle size (diameter) in the range from about 1 μm to about 3 μm. Other glass compositions may be utilized. The particles may be formed by milling. The particles may be added to an antimicrobial agent-containing solution having a composition as described herein for a duration of time, as otherwise described herein. The solution may be agitated while the particles are immersed, to prevent particle settling. The resulting particles may be combined with carriers such as polymers. The combination of particles and polymer may include about 5 wt % to about 15 wt % particles. The resulting combination may be adhered directly to a variety of surfaces or be molded into articles.

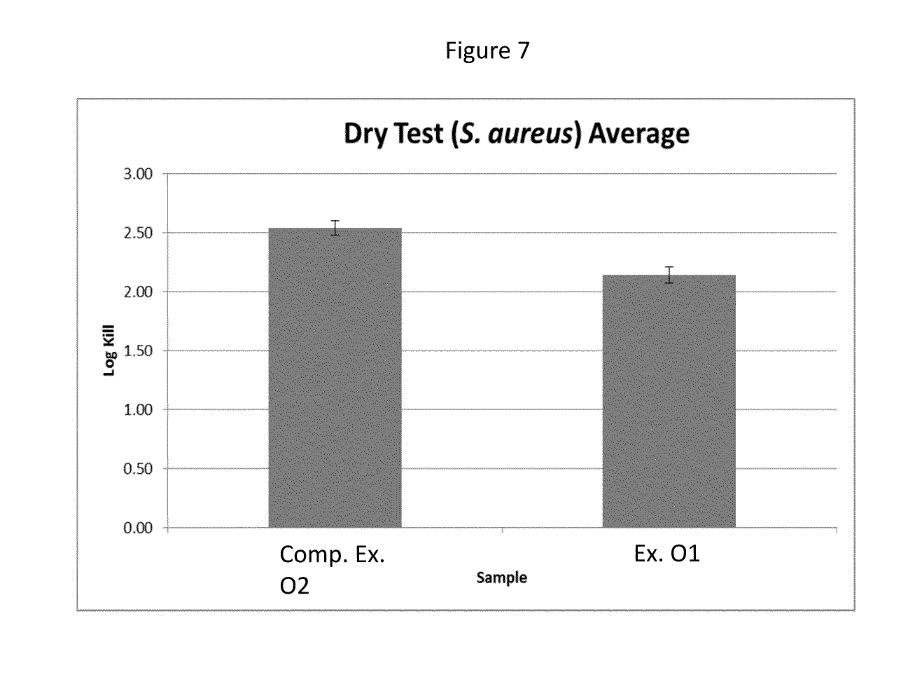

Example O1 was prepared by providing a spool of flexible glass sheet that was wound onto a spool. The glass sheet was formed by drawing a substrate having the same composition as Substrate A and redrawing the substrate to achieve a thickness of about 50 μm. The sheet was rolled onto a spool with a permeable membrane separating the glass sheet from itself as it is wound onto the spool. The permeable membrane also facilitates access to portions of the glass sheet not at the surface of the spool. The spool was immersed in a bath of antimicrobial agent-containing solution K24 having a temperature of 95° C. for 96 hours. The spool was removed and the glass sheet was unrolled and cut into squares having dimensions of 1″ by 1″. The squares were then subjected to the Dry Test, the results of which are shown in FIG. 7. For comparison, Substrate E was subjected to AA Condition 3, at a temperature of about 350° C. for 20 minutes (Comparative Example O2). As shown in FIG. 7, both Example 01 and Comparative Example O2 exhibited a log kill of greater than about 2 under the Dry Test for S. aureus.

While the embodiments disclosed herein have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of the present disclosure or the appended claims.

What is claimed is:

1. An antimicrobial article comprising:
a glass, ceramic, or glass-ceramic substrate, a compressive stress layer that extends inward from a surface of the glass, ceramic, or glass-ceramic substrate to a first depth therein, and an antimicrobial agent-containing region that extends inward from the surface of the glass, ceramic, or glass-ceramic substrate to a second depth therein, wherein the second depth is less than or equal to about 500 nanometers.

2. The antimicrobial article of claim 1, wherein the compressive stress layer comprises at least one of potassium ions and sodium ions.

3. The antimicrobial article of claim 1, further comprising an additional layer disposed on the surface of the glass, ceramic, or glass-ceramic substrate, wherein the additional layer comprises a reflection-resistant coating, a glare-resistant coating, fingerprint-resistant coating, smudge-resistant coating, a color-providing composition, an environmental barrier coating, or an electrically conductive coating.

4. The antimicrobial article of claim 3, wherein the second depth is substantially stable after combination with the additional layer.

5. The antimicrobial article of claim 1, wherein the a glass, ceramic, or glass-ceramic substrate comprises a thickness of about 0.8 mm or less and a compressive stress of the compressive stress layer is in the range from 200 megapascals to about 1.2 gigapascals and the first depth is less than about 200 micrometers.

6. The antimicrobial article of claim 1, wherein the antimicrobial agent comprises a cationic monovalent silver species, cationic monovalent copper species, cationic divalent zinc species, and/or a quaternary ammonium species.

7. The antimicrobial article of claim 1, wherein the second depth is in the range from about 2 nanometers to about 500 nanometers.

8. The antimicrobial article of claim 1, wherein the surface is etched.

9. The antimicrobial article of claim 1, wherein an antimicrobial agent concentration of an outermost 3 nanometers of the antimicrobial agent-containing region is up to about 10 atomic percent, based on a total number of atoms of the outermost 3 nanometers of the antimicrobial agent-containing region.

10. The antimicrobial article of claim 1, wherein an antimicrobial article exhibits at least a 2 log reduction in the concentration of at least Staphylococcus aureus, Enterobacter aerogenes, and Pseudomomas aeruginosa bacteria under a Dry Test.

11. The antimicrobial article of claim 1, wherein the antimicrobial article exhibits at least a 3 log reduction in a concentration of at least Staphylococcus aureus, Enterobacter aerogenes, and Pseudomomas aeruginosa bacteria under JIS Z 2801 (2000) testing conditions.

12. The antimicrobial article of claim 1, wherein the antimicrobial article exhibits at least a 1 log reduction in a concentration of at least Staphylococcus aureus, Enterobacter aerogenes, and Pseudomomas aeruginosa bacteria under modified JIS Z 2801 (2000) testing conditions, wherein modified conditions comprise heating the antimicrobial article to a temperature of about 23 degrees Celsius to about 37 degrees Celsius at a humidity of about 38 percent to about 42 percent for about 24 hours followed by drying for about 6 hours to about 24 hours.

13. The antimicrobial article of claim 1, wherein the antimicrobial article comprises a portion of a touch-sensitive display screen or cover plate for an electronic device, a non-touch-sensitive component of an electronic device, a surface of a household appliance, a surface of medical equipment, a surface of an architectural component, a biological or medical packaging vessel, or a surface of a vehicle component.

14. The antimicrobial article of claim 3, wherein the antimicrobial article exhibits the substantially the same log reduction in the concentration of at least Staphylococcus aureus, Enterobacter aerogenes, and Pseudomomas aeruginosa bacteria under the Dry Test conditions, before and after formation of the additional layer.

15. An antimicrobial article, comprising:
a glass, ceramic, or glass-ceramic substrate, an antimicrobial agent-containing region that extends inward from the surface of the glass, ceramic, or glass-ceramic substrate to a depth therein of less than or equal to about 500 nanometers,
wherein an antimicrobial agent concentration of an outermost 3 nanometers of the antimicrobial agent-containing region is up to about 10 atomic percent, based on a total number of atoms of the outermost 3 nanometers of the antimicrobial agent-containing region, and
wherein the glass, ceramic or glass-ceramic substrate comprises a substantially uniform compressive stress.

16. A method of making an antimicrobial article comprising:
providing a glass, ceramic, or glass-ceramic substrate having a surface; and
forming an antimicrobial agent-containing region that extends inward from the surface of the glass, ceramic, or glass-ceramic substrate to a depth or region, wherein the depth of region is less than or equal to about 500 nanometers.

17. The method of claim 16, wherein forming an antimicrobial agent-containing region comprises simultaneously etching the surface.

18. The method of claim 16, wherein forming the antimicrobial agent-containing region comprises:
contacting at least a portion of the surface of the glass, ceramic, or glass-ceramic substrate with an antimicrobial agent-containing solution effective to introduce antimicrobial agent on and into the glass, ceramic, or glass-ceramic substrate to the depth or region,
wherein the antimicrobial agent-containing solution comprises at least one of AgNO₃, CuCl, a combination of AgNO₃ and Zn(NO₃)₂, and a combination of AgNO₃ and KNO₃.

19. The method of claim 18, wherein the antimicrobial agent-containing solution has a pH in the range from about 4 to about 10.

20. The method of claim 18, wherein the contacting occurs for less than or equal to about 24 hours at a temperature of less than or equal to about 140 degrees Celsius.

21. The method of claim 16, wherein the depth of region is in the range from about 2 nanometers to about 500 nanometers.

22. The method of claim 16, wherein an antimicrobial agent concentration of an outermost 3 nanometers of the antimicrobial agent-containing region is up to about 10 atomic percent, based on a total number of atoms of the outermost 3 nanometers of the antimicrobial agent-containing region.

23. The method of claim 16, further comprising forming an additional layer on at least a portion of the surface of the glass, ceramic, or glass-ceramic substrate, wherein the additional layer comprises a reflection-resistant coating, a glare-resistant coating, fingerprint-resistant coating, smudge-resistant coating, a color-providing composition, an environmental barrier coating, or an electrically conductive coating.

24. The method of claim 23, wherein forming the additional layer occurs before forming the antimicrobial agent-containing region.

25. The method of claim 16, further comprising forming a compressive stress layer in the glass, ceramic, or glass-ceramic substrate by thermal tempering or chemical ion exchanging, wherein the compressive stress layer extends inward from the surface of the glass, ceramic, or glass-ceramic substrate to a compressive stress depth, wherein the depth of region is less than the compressive stress depth.

26. The method of claim 25, wherein forming the compressive stress layer comprises immersing the glass, ceramic or glass-ceramic substrate in a molten salt bath comprising at least one of KNO₃ and NaNO₃ before or after forming the antimicrobial agent-containing region.
